(19) United States
(12) Patent Application Publication
(10) Pub. No.: US 2024/0195022 A1
(43) Pub. Date: Jun. 13, 2024

(54) BATTERY MODULE AND MANUFACTURING METHOD THEREOF

(71) Applicant: SK On Co., Ltd, Seoul (KR)

(72) Inventors: Sang Tae AN, Daejeon (KR); Gang U LEE, Daejeon (KR); Ho Yeon KIM, Daejeon (KR); Hwa Kyoo YOON, Daejeon (KR); Jeong Woo HAN, Daejeon (KR)

(21) Appl. No.: 18/535,710

(22) Filed: Dec. 11, 2023

(30) Foreign Application Priority Data
Dec. 12, 2022 (KR) 10-2022-0173080

(51) Int. Cl. H01M 50/505; H01M 10/058; H01M 50/264; H01M 50/533

(52) U.S. Cl. CPC H01M 50/505; H01M 10/058; H01M 50/264; H01M 50/533; H01M 10/052

(57) ABSTRACT

A battery module comprises a cell assembly formed by stacking a plurality of battery cells, each battery cell comprising at least two electrode tabs; and a bus bar assembly disposed on a side of the cell assembly where the electrode tab protrudes comprising a plurality of slit holes each of which is penetrated by at least one of the plurality of electrode tabs. The slit holes each comprises a first area and a second area having a wider width than that of the first area. At least one of the electrode tabs comprises a first portion and a second portion having a length in a direction in which the electrode tab protrudes which is shorter than a length of the first portion, and wherein the first portion penetrates the first area portion, and the second portion faces the second area.

### CROSS-REFERENCE TO RELATED PATENT APPLICATION

The present application claims priority under 35 U.S.C. § 119(a) to Korean patent application number 10-2022-0173080 filed on Dec. 12, 2022, the entire disclosure of which is incorporated by reference herein.

### BACKGROUND OF THE INVENTION

### 1. Field

Various embodiments of the present invention relate generally to a battery module and a manufacturing method thereof.

### 2. Description of the Related Art

With the development of the electronics, communications, and space industries, demand for lithium secondary batteries as an energy power source is rapidly increasing. In particular, as the importance of global eco-friendly policies is emphasized, the electric vehicle market is growing drastically, and research and development on lithium secondary batteries are being actively conducted in Korea and other countries.

Typically, a lithium secondary battery comprises a cathode, an anode, and a separator disposed therebetween. The cathode and anode are each provided with an active material into which lithium ions can be inserted and extracted.

A plurality of battery cells in a lithium secondary battery module can be electrically connected by coupling individual battery cells to a bus bar assembly in a cell assembly in which the plurality of battery cells are stacked. There is a need for a new type of secondary battery module and an assembly method capable of improving the assembly of such a secondary battery module.

### SUMMARY OF THE INVENTION

The present invention provides generally a new type of battery module and a manufacturing method thereof.

According to an embodiment of the present invention, a battery module may comprise a cell assembly formed by stacking a plurality of battery cells, each battery cell comprising at least two electrode tabs; and a bus bar assembly disposed on a side of the cell assembly where the electrode tab protrudes, electrically interconnecting the plurality of battery cells through a plurality of electrode tabs and comprising a plurality of slit holes each of which is penetrated by at least one of the plurality of electrode tabs, wherein the slit holes each comprise a first area and a second area having a wider width than that of the first area, and wherein at least one of the electrode tabs comprises a first portion and a second portion having a length in a direction in which the electrode tab protrudes which is shorter than a length of the first portion, and wherein the first portion penetrates the first area portion, and the second portion faces the second area.

A battery module, according to an embodiment of the present invention, may comprise a cell assembly formed by mutually stacking a plurality of battery cells each comprising at least two electrode tabs; a connection plate comprising a rotatable fastening portion and being disposed at a lower end of the cell assembly in a direction perpendicular to a direction in which electrode tabs protrude from the battery cells; and a bus bar assembly being disposed on a side of the cell assembly where the electrode tab protrudes, electrically interconnecting the plurality of battery cells through the plurality of electrode tabs and being hinged to the connection plate through the fastening portion, wherein the bus bar assembly comprises a plurality of slit holes each of which is penetrated by at least one of the plurality of electrode tabs, and wherein the slit holes each comprise a first area and a second area which is disposed at an end in a direction adjacent to the fastening portion and which has a wider width than that of the first area.

A battery module manufacturing method according to an embodiment of the present invention may comprise connecting a bus bar assembly to a fastening portion disposed at an upper portion or a lower portion of a cell assembly formed by mutually stacking a plurality of battery cells each comprising at least two electrode tabs; and penetrating at least one of electrode tabs through each of a plurality of slit holes included in the bus bar assembly by rotating the bus bar assembly around the fastening portion, wherein the slit holes each comprise a first area and a second area which is disposed more adjacently to the fastening portion than the first area and which has a wider width than that of the first area.

According to the present technology, a new type of battery module with improved assemblability, and a manufacturing method thereof are provided.

These and other features and advantages of the present invention will become better understood from the following drawings and detailed description.

### BRIEF DESCRIPTION OF THE DRAWINGS

FIG. 1 is a diagram illustrating a battery module according to an embodiment of the present invention.

FIGS. 2A, 2B, 3, 4A and 4B are diagrams illustrating the internal structure of a battery module.

FIGS. 5A, 5B, 6, and 7 are diagrams illustrating the coupling of a bus bar assembly in a battery module according to an embodiment of the present invention.

FIG. 8 is a diagram illustrating a slit hole of a battery module according to an embodiment of the present invention.

FIG. 9 is a diagram illustrating an electrode tab of a battery module according to an embodiment of the present invention.

FIG. 10 is a diagram illustrating a battery module according to another embodiment of the present invention.

FIG. 11 is a flowchart illustrating a battery module manufacturing method according to an embodiment of the present invention.

### DETAILED DESCRIPTION

Structural or functional descriptions of embodiments disclosed in the present specification are merely illustrated for the purpose of describing the embodiments according to the technical principle of the present invention. In addition, embodiments according to the technical principle of the present invention may be implemented in various forms other than the embodiments disclosed in the present specification. In addition, the technical principle of the present invention is not to be construed as being limited to the embodiments described in this specification.

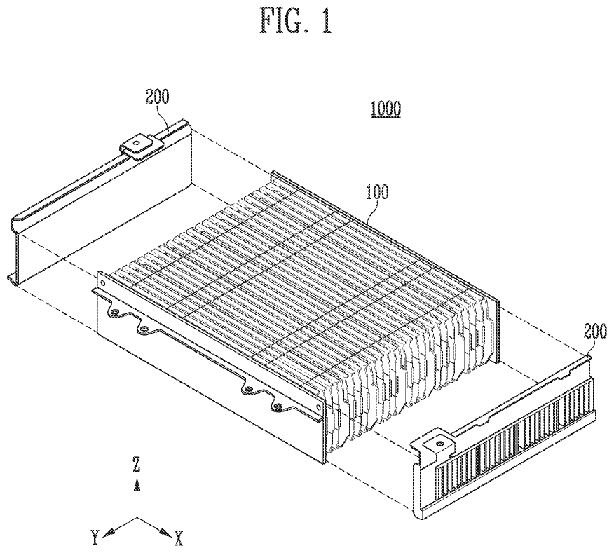

FIG. 1 is a diagram illustrating a battery module according to an embodiment of the present invention.

Referring to FIG. 1, a battery module 1000 may comprise a cell assembly 100 and a bus bar assembly 200.

A cell assembly 100 may be formed by mutually stacking a plurality of battery cells. A battery cell may comprise a cathode, an anode, and a separator disposed therebetween.

The cathode and anode may each comprise a current collector and an active material layer disposed on the current collector. For example, the cathode may comprise a cathode current collector and a cathode active material layer, and the anode may comprise an anode current collector and an anode active material layer.

A current collector may comprise a known conductive material within a range that does not cause a chemical reaction in a lithium secondary battery.

An active material layer comprises an active material. For example, a cathode active material layer may comprise a cathode active material, and an anode active material layer may comprise an anode active material. A cathode active material may be a material in which lithium (Li) ions can be intercalated and deintercalated. An anode active material may be a material in which Li ions can be intercalated and deintercalated.

A cathode and an anode may each further comprise a binder and a conductive material. A binder can improve the mechanical stability by mediating the binding between a current collector and an active material layer. A conductive material can improve electrical conductivity of lithium secondary batteries.

A separator may be disposed between a cathode and an anode. A separator may be configured to prevent an electrical short circuit between a cathode and an anode and to generate a flow of ions.

Each battery cell may comprise at least one electrode tab protruding in one direction.

A bus bar assembly 200 may be disposed on the side where electrode tabs of a cell assembly 100 protrude. A bus bar assembly 200 may electrically interconnect a plurality of battery cells included in a cell assembly 100 through electrode tabs included in a cell assembly 100. Here, a direction in which the electrode tabs protrude from a cell assembly 100 may be perpendicular to a direction in which battery cells of a cell assembly 100 are stacked.

The bus bar assembly 200 may comprise a plurality of slit holes. As electrode tabs penetrate corresponding slit holes, the bus bar assembly 200 may be coupled to the cell assembly 100.

In addition, the battery module 1000 may further comprise an upper plate disposed at an upper portion of the cell assembly 100, a lower plate disposed at a lower portion of the cell assembly 100, and an end plate disposed at an end in a direction in which battery cells are stacked. However, to highlight the features of the present invention, drawings and descriptions related thereto will be omitted.

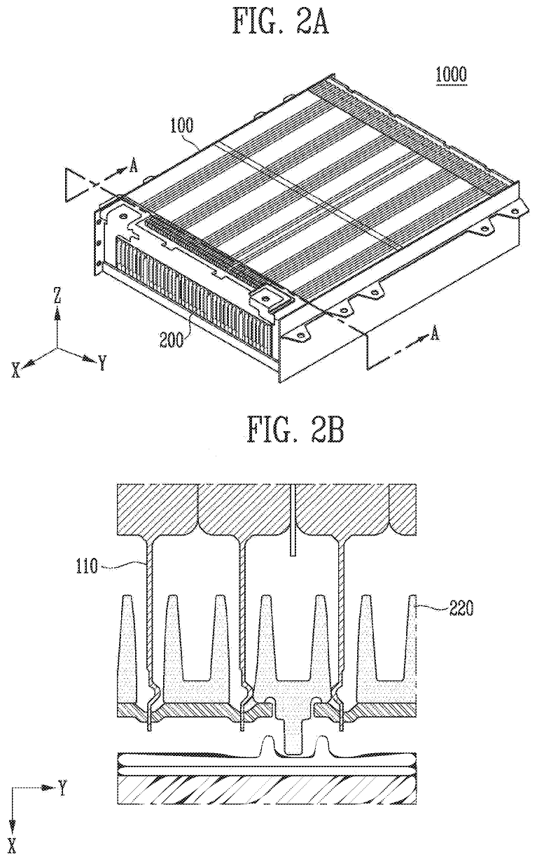

FIGS. 2A, 2B, 3, 4A and 4B are diagrams illustrating the internal structure of a battery module.

FIGS. 2A and 2B show a battery module 1000 in which the bus bar assembly 200 is coupled to the cell assembly 100. Here, FIG. 2B shows an A-A cross-section of FIG. 2A. The bus bar assembly 200 may further comprise a protruding portion 220 protruding toward the cell assembly 100. In a state where the bus bar assembly 200 is coupled to the cell assembly 100, the protruding portion 220 may be disposed between electrode tabs 110. The protruding portion 220 may have a structure surrounding a terrace portion of a battery cell included in the cell assembly 100. Here, the terrace of the battery cell may refer to an empty space existing between electrode tabs of battery cells that are adjacent to each other. The protruding portion 220 may be designed to avoid an accommodating portion of the battery cell in which an electrode assembly of a battery cell is accommodated. The protruding portion 220 may extend in a height direction of the cell assembly 100. Here, a height direction of the cell assembly 100 may be a direction perpendicular to both a direction in which battery cells are stacked and a direction in which electrode tabs protrude from the cell assembly 100.

In the present specification, an upper portion and a lower portion may refer to an upper portion and a lower portion in a height direction, and an upper end and a lower end may refer to an end in an upper direction and an end in a lower direction, respectively.

In the present specification, a height direction of the cell assembly 100 may refer to the Z-axis direction. Furthermore, a direction in which battery cells are stacked may refer to the Y-axis direction, and a direction in which electrode tabs protrude from the cell assembly 100 may refer to the X-axis.

For example, the protruding portion 220 may be configured to have a height from a lower end of the battery cell to a sealing portion of the battery cell or an upper end of the battery cell. The protruding portion 220 may have a structure surrounding the terrace portion of the terrace of the battery cell and extending in a height direction of the cell assembly 100 to induce a gas discharged from the battery cell of the cell assembly 100 to move in a specific direction, for example, a height direction.

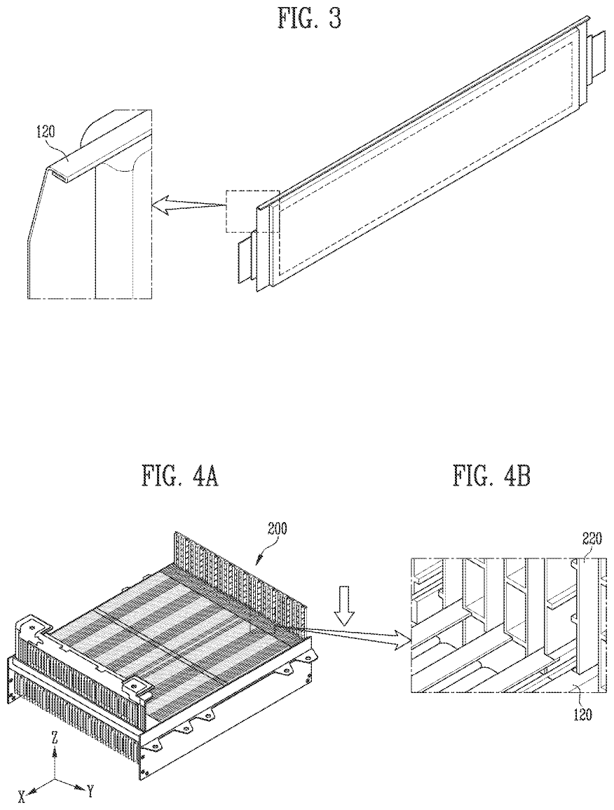

FIG. 3 shows one of the battery cells included in the cell assembly 100. The cell assembly 100 may comprise at one end a folding portion 120 extending in a direction in which the battery cells are stacked. In one embodiment, as shown in FIG. 3, the cell assembly 100 may comprise a folding portion 120 at an upper end. In the folding portion 120, a part of a housing of the battery cell may be folded and adhered to seal an accommodation portion of the battery cell in which the electrode assembly of the battery cell is accommodated.

Although an empty space in which the protruding portion 220 can be disposed between electrode tabs of different battery cells, that is, a terrace of a battery cell is secured at a lower portion of the folding portion 120, since the folding portion 120 extends in a direction in which the battery cells are stacked, when coupling of the bus bar assembly 200 is tried in a height direction of the cell assembly, the folding portion 120 disposed at the upper end of the cell assembly 100 and the protruding portion 220 of the bus bar assembly 200 may collide with each other and thus the cell assembly 100 may not be assembled in a height direction.

FIGS. 4A and 4B show the bus bar assembly 200 and the cell assembly 100 before being coupled into a battery module 1000. Here, FIG. 4B is an enlarged portion of FIG. 4A. That is, as shown in FIGS. 4A and 4B, when coupling of the bus bar assembly 200 is tried in a height direction of a cell assembly, the folding portion 120 disposed at an upper end of the cell assembly 100 and the protruding portion 220 of the bus bar assembly 200 may collide with each other.

However, as shown in FIGS. 2A and 2B, in a state in which the cell assembly 100 and the bus bar assembly 200 are already assembled, since the folding portion 120 is disposed at an upper portion of the protruding portion 220, interference between the protruding portion 220 and the folding portion 120 may not exist. When a coupling portion of the cell assembly 100 and the bus bar assembly 200 is viewed from a height direction, the protruding portion 220 and the folding portion 120 may overlap each other, but in reality, the protruding portion 220 and the folding portion 120 are disposed at an upper portion in a height direction and at lower portion in the height direction, respectively, at one end of the battery module. Therefore, the protruding portion 220 and the folding portion 120 may not interfere with each other. Therefore, in one embodiment of the present invention, a direction in which the bus bar assembly 200 is coupled to the cell assembly 100 may be adjusted to improve the assemblability of a bus bar assembly 200.

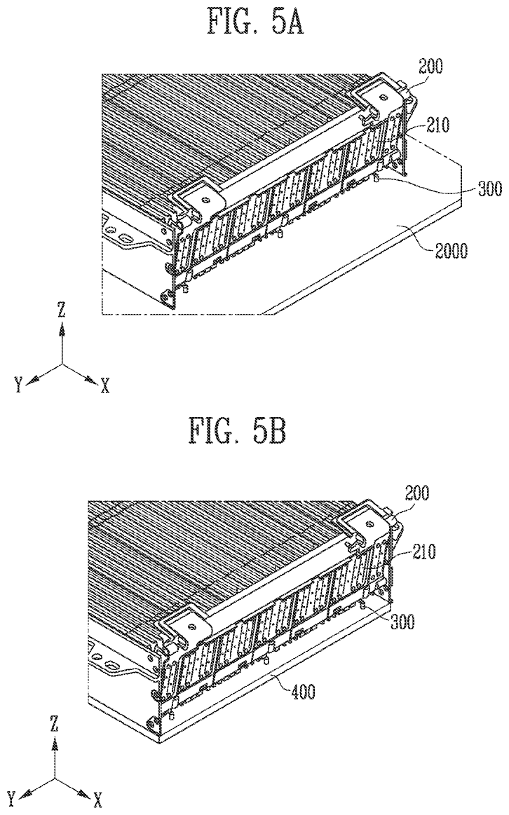

FIGS. 5A, 5B, 6, and 7 are diagrams illustrating the coupling of a bus bar assembly in a battery module according to an embodiment of the present invention.

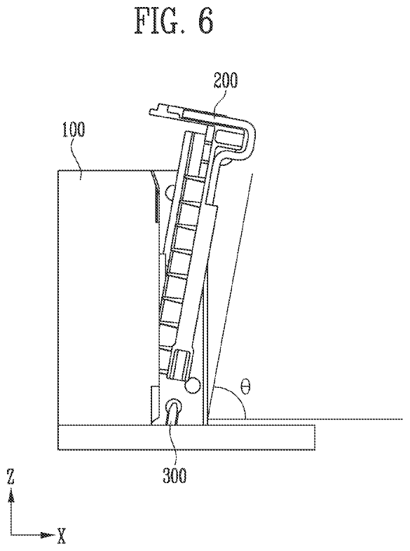

Referring to FIGS. 5A, 5B and 6, the bus bar assembly 200 may be coupled to the cell assembly 100 from a tilted state at a predetermined angle with respect to a height direction of a cell assembly 100. The bus bar assembly 200 may comprise a plurality of slit holes 210. The bus bar assembly 200 may be coupled to the cell assembly 100 by passing one or more electrode tabs through each of the slit holes. As at least one electrode tab penetrates each slit hole, the bus bar assembly 200 may be coupled to the cell assembly 100.

In one embodiment, as a bus bar assembly 200 rotates after being coupled to fastening elements 300, electrode tabs may penetrate slit holes 210. The fastening elements 300 may rotate around a direction in which battery cells are stacked. In FIGS. 5A, 6, and 7, fastening elements 300 illustrated as a component of an assembly jig 2000, which is separate from a battery module 1000, but the embodiment is not limited thereto, and as shown in FIG. 5B, a fastening elements 300 may be a component of a connection plate 400 included in the battery module 1000.

Referring to FIG. 6, the bus bar assembly 200 may be connected to the fastening elements 300 to form an angle θ with a direction in which an electrode tab protrudes. Here, θ may be 0°<θ<90°.

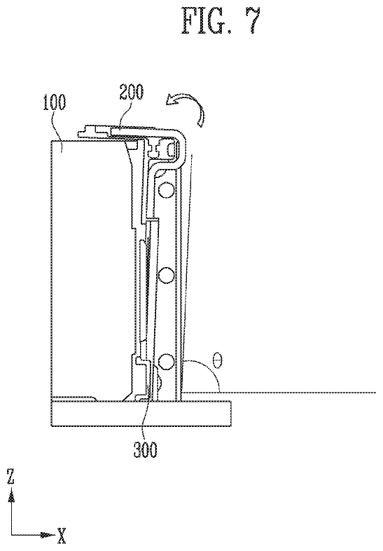

Referring to FIG. 7, the bus bar assembly 200 may rotate around a direction in which battery cells are stacked by the fastening elements 300. The bus bar assembly 200 may rotate in a direction in which θ increases. Therefore, electrode tabs of the cell assembly 100 may penetrate the slit holes of the bus bar assembly 200.

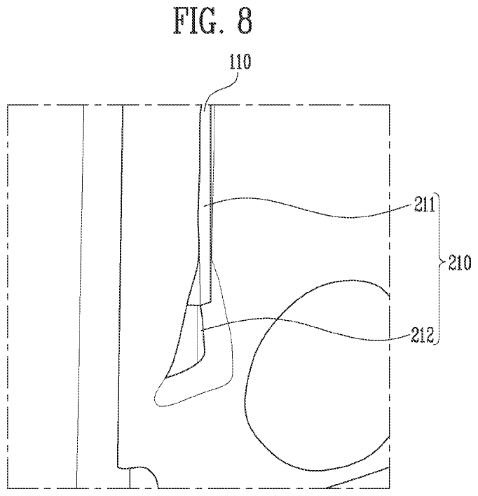

FIG. 8 is a diagram illustrating a slit hole of a battery module according to an embodiment of the present invention.

Referring to FIG. 8, a slit hole 210 may comprise a first area 211 and a second area 212. The width of the second area 212 may be greater than that of a first area 211. A slit hole 210 may extend in a direction perpendicular to both a direction in which battery cells are stacked and a direction in which an electrode tab 110 protrudes from the cell assembly, which may be a height direction of the cell assembly. The second area 212 may be formed at one end in a direction in which a slit hole 210 extends.

Hence, an electrode tab 110 may penetrate a corresponding slit hole 210.

In FIG. 8, the second region 212 of the slit hole 210 is illustrated as a triangular cross-section that becomes wider toward an end, but is not limited thereto, and any cross-section having a shape in which the width is wider than that of the first area 211 may be applied without limitation.

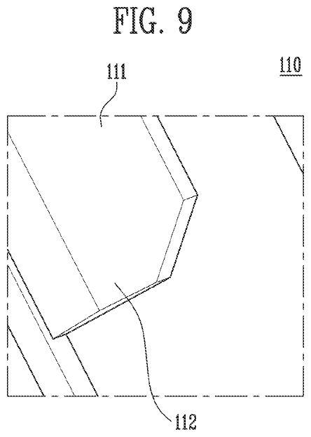

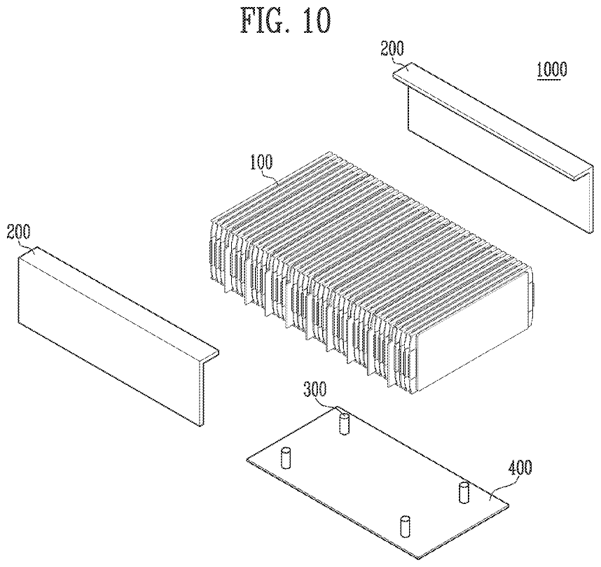

FIG. 9 is a diagram illustrating an electrode tab of a battery module according to an embodiment of the present invention.

Referring to FIG. 9, the electrode tab 110 may comprise a first portion 111 and a second portion 112. In one embodiment, the length of the second portion 112 in a direction in which the electrode tab 110 protrudes may be shorter than the length of the first portion 111 in a direction in which the electrode tab 110 protrudes. In an embodiment, the first portion 111 may penetrate the first area 211 of the slit hole 210 of FIG. 8, and the second portion 112 may face the second area 211 of the slit hole 210 of FIG. 8.

FIG. 10 is a diagram illustrating a battery module according to another embodiment of the present invention.

Referring to FIG. 10, battery module 1000 may comprise the cell assembly 100, the bus bar assembly 200, and the connection plate 400.

Since all of the descriptions about the cell assembly 100 and the bus bar assembly 200 in FIGS. 1 to 8 may also be applied here, descriptions thereof may now be omitted.

In an embodiment, the connection plate 400 may be disposed at an end of the cell assembly 100 in a height direction. For example, the connection plate 400 may be disposed at a lower portion, e.g., a bottom side of the cell assembly 100 as shown in FIG. 5B and FIG. 10.

The connection plate 400 may comprise fastening elements 300, e.g., a plurality of fastening elements 300. The fastening elements 300 may be spaced apart from each other at a regular interval and may be arranged in at least one or at least two rows. For example, the fastening elements 300 may be rotatable. In one embodiment, the fastening elements 300 may rotate around a direction in which the battery cells are stacked.

The bus bar assembly 200 may be coupled to the connection plate 400 via the fastening elements 300. For example, in one embodiment, the bus bar assembly 200 may be hinged to the connection plate 400 through the fastening elements 300.

In the embodiment of FIG. 10, unlike FIGS. 5a, 6, and 7 in which a fastening element 300 is formed in an assembly jig 2000 separate from the battery module 1000, in the embodiment of FIG. 10, the fastening element or elements, which is a component of the battery module 1000, may be included in the connection plate 400.

The bus bar assembly 200 may comprise a plurality of slit holes 210, as described in FIG. 8. The first area 211 of the slit hole 210, having a relatively narrow width, may be formed at a position relatively far from the fastening elements 300, and the second area 212 of the slit hole 210, having a relatively wide width, may be formed at a position relatively close to the fastening elements 300. For example, the second region 212 may be disposed at an end in a direction adjacent to the fastening elements 300.

In addition, the battery module 1000 may further comprise an upper plate disposed at an end opposite to the connection plate 400 and an end plate disposed at an end in a direction in which battery cells are stacked. However, to highlight the features of the present invention, drawings and descriptions related thereto will be omitted.

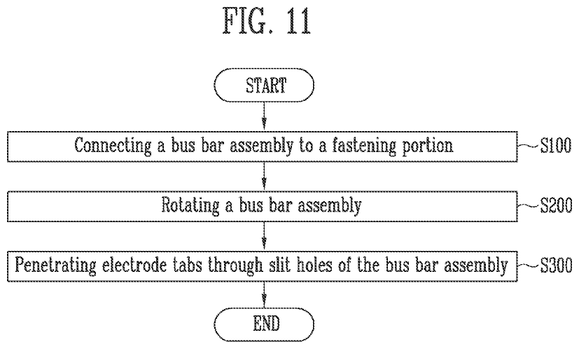

FIG. 11 is a flowchart illustrating a battery module manufacturing method according to an embodiment of the present invention.

Referring to FIGS. 6 to 11, the bus bar assembly 200 may be connected to the fastening elements 300 in operation S100. The fastening elements 300 may be disposed at an upper portion or a lower portion of the cell assembly 100 formed by stacking a plurality of battery cells each including an electrode tab. Here, an upper portion or a lower portion may refer to an end in a direction perpendicular to both a direction in which battery cells are stacked and a direction in which electrode tabs of a battery cells protrude, which is, a height direction of a cell assembly 100.

In one embodiment, the fastening elements 300 may be included in the assembly jig 2000, which is a component separate from a battery module 1000, as shown in FIGS. 5a, 6, and 7. In another embodiment, the fastening elements 300 may be included in a connection plate 400 of a battery module 1000, as shown in FIG. 10.

In operation S100, a bus bar assembly 200 may be connected to the fastening elements 300 to form an angle θ with a direction in which an electrode tab protrudes. Here, θ may be an angle of 0°<θ<90°.

In operation S200, the bus bar assembly 200 may be rotated according to the rotation of the fastening elements 300. The bus bar assembly 200 and the fastening elements 300 may rotate around a direction in which battery cells are stacked.

Accordingly, in operation S300, electrode tabs 110 may penetrate slit holes 210 of the bus bar assembly 200. A slit hole 210 may comprise the first area 211 and the second area 212 which is disposed more adjacent to the fastening elements 300 than the first area 211 and which has a wider width than that of the first area 211. In one embodiment, the second area 212 may be formed at an end adjacent to the fastening elements 300.

In addition, each of the electrode tabs 110 may comprise a first portion 111 penetrating a first area 211 and a second portion 112 facing a second area 212. In operation S300, the second portion 112 may penetrate the slit hole 210 earlier than the first portion 111. The electrode tab 110 may be the first one that penetrates the second area 212 of the slit hole 210. Accordingly, for the electrode tab 110 to penetrate a slit hole more conveniently, the width of the second area 212, which the electrode tab 110 first penetrates, may be wider than the width of the first area 211, which the electrode tab 110 penetrates later or simply faces adjacently without penetrating.

At this time, cutting may be necessary because bending of an edge portion of an electrode tab may occur to a great extent. Therefore, in one embodiment, the length of the second portion 112 in a direction in which the electrode tab 110 protrudes may be shorter than the length of the first portion 111 in a direction in which the electrode tab 110 protrudes. However, since it is preferable for a second portion 112 to pass through a slit hole 210 first in an electrode tab 110 to contact a slit hole 210 as quickly as possible, the length difference between the first portion 111 and the second portion 112 may preferably be minimized.

When the fastening elements 300 are included in an assembly jig 2000 as shown in FIGS. 5a, 6, and 7, after operation S300, an operation of separating a battery module to which a bus bar assembly 200 is assembled from an assembly jig 2000 may be further included.

In a battery module manufacturing method according to an embodiment of the present invention, a cell assembly is assembled to a cell assembly 100 to form an angle of 0°<θ<90° with a direction in which an electrode tab protrudes to prevent collision between the protruding portion of the bus bar assembly 200 protruding in a direction of the cell assembly 100 and the folding portion 120 at an upper end of the cell assembly 100 protruding in a direction in which battery cells are stacked which improves the assemblability of the battery module 1000. Here, “θ” (“theta”) may refer to an angle formed between a direction in which an electrode tab protrudes and a direction in which a bus bar assembly 200 and a cell assembly 100 are connected to each other.

For example, when the bus bar assembly 200 is assembled to the cell assembly 100 to form an angle of 0° with a direction in which an electrode tab protrudes, that is, in a direction in which an electrode tab protrudes, since it is difficult for electrode tabs 110 to penetrate the slit holes 210 of the bus bar assembly 200, the assemblability of a battery module 1000 may be low.

In addition, when a bus bar assembly 200 is assembled to the cell assembly 100 to form an angle of 90° with a direction in which an electrode tab protrudes, that is, in a height direction of a cell assembly, as described above with reference to FIGS. 4A and 4B, collision may occur between a protruding portion of a bus bar assembly 200 and a folding portion 120 of an upper end of a cell assembly 100.

On the other hand, in a battery module manufacturing method according to an embodiment of the present invention, after the bus bar assembly 200 is assembled to the cell assembly 100 through the fastening elements 300 to form an angle of 0°<θ<90° with a direction in which an electrode tab protrudes, by the rotation of the bus bar assembly 200 through the fastening elements 300, electrode tabs 100 penetrate slit holes 210 of the bus bar assembly 200, and so all the issues described above can be resolved.

What is claimed is:

1. A battery module comprising:
a cell assembly formed by stacking a plurality of battery cells, each battery cell comprising at least two electrode tabs; and
5 a bus bar assembly disposed on a side of the cell assembly where the electrode tab protrudes, electrically interconnecting the plurality of battery cells through a plurality of electrode tabs and comprising a plurality of slit holes each of which is penetrated by at least one of the plurality of electrode tabs,
wherein the slit holes each comprise a first area and a second area having a wider width than that of the first area, and
wherein at least one of the electrode tabs comprises a first portion and a second portion having a length in a direction in which the electrode tab protrudes which is shorter than a length of the first portion, and
wherein the first portion penetrates the first area portion, and the second portion faces the second area.

2. The battery module according to claim 1, wherein each of the slit holes extends in a direction perpendicular to both a direction in which the battery cells are stacked and a direction in which the electrode tabs protrude.

3. The battery module according to claim 2, wherein the second area is formed at one end in a direction in which the slit holes extend.

4. The battery module according to claim 1, wherein the bus bar assembly further comprises a protruding portion protruding in a direction toward the cell assembly.

5. The battery module according to claim 4, wherein the cell assembly further comprises at one end a folding portion extending in a direction in which the battery cells are stacked.

6. The battery module according to claim 5, wherein the protruding portion and the folding portion overlap each other when viewed from a direction perpendicular to both the direction in which the battery cells are stacked and a direction in which the electrode tabs protrude.

7. A battery module comprising:
a cell assembly formed by stacking a plurality of battery cells each comprising an electrode tab;
a connection plate comprising a rotatable fastening portion, the connection plate being disposed at a lower end of the cell assembly in a direction perpendicular to a direction in which electrode tabs protrude from the battery cells; and
a bus bar assembly disposed on a side of the cell assembly where the electrode tab protrudes, the bus bar assembly electrically interconnecting the plurality of battery cells through the plurality of electrode tabs and being hinged to the connection plate through the fastening portion,
wherein the bus bar assembly comprises a plurality of slit holes each of which is penetrated by at least one of the plurality of electrode tabs, and
wherein the slit holes each comprise a first area and a second area which is disposed at an end in a direction adjacent to the fastening portion and which has a wider width than that of the first area.

8. The battery module according to claim 7, wherein at least one of the electrode tabs comprises a first portion penetrating the first area; and
a second portion which faces the second area and of which the length in a direction in which the electrode tab protrudes is shorter than that of the first portion.

9. The battery module according to claim 7, wherein the bus bar assembly further comprises a protruding portion protruding toward the cell assembly.

10. The battery module according to claim 9, wherein the cell assembly further comprises at an upper end a folding portion extending in a direction in which the battery cells are stacked.

11. The battery module according to claim 10, wherein the protruding portion and the folding portion overlap each other when viewed from an upper end of the cell assembly toward a lower end of the cell assembly.

12. A battery module manufacturing method comprising:
connecting a bus bar assembly to a fastening portion disposed at an upper portion or a lower portion of a cell assembly formed by stacking a plurality of battery cells each comprising an electrode tab; and
penetrating at least one of electrode tabs through each of a plurality of slit holes included in the bus bar assembly by rotating the bus bar assembly around the fastening portion,
wherein the slit holes each comprise a first area and a second area which is disposed more adjacent to the fastening portion than the first area and which has a wider width than that of the first area.

13. The battery module manufacturing method according to claim 12, wherein the battery module further comprises a connection plate disposed at an upper end or a lower end of the cell assembly to interconnect at least one bus bar assembly, and
wherein the fastening portion is disposed on the connection plate.

14. The battery module manufacturing method according to claim 12, wherein connecting a bus bar assembly to a fastening portion further comprises disposing the cell assembly on an assembly jig, and
wherein the fastening portion is disposed on the assembly jig.

15. The battery module manufacturing method according to claim 14, further comprising separating the battery module to which the bus bar assembly is assembled from the assembly jig.

16. The battery module manufacturing method according to claim 12, wherein, in the connecting a bus bar assembly to a fastening portion, the bus bar assembly is connected to the fastening portion to form an angle of 0° to 90° with a direction in which the electrode tab protrudes.

17. The battery module manufacturing method according to claim 16, wherein the penetrating the electrode tabs through a plurality of slit holes is performed such that the bus bar assembly is rotated in a direction that increases an angle between the bus bar assembly and a direction in which the electrode tab protrudes.

18. The battery module manufacturing method according to claim 12, wherein each of the electrode tabs comprises a first portion penetrating the first area portion, and a second portion facing the second area, and
wherein the second portion is disposed at an end in a direction adjacent to the coupling portion of each of the electrode tabs.

19. The battery module manufacturing method according to claim 18, wherein the second portion penetrates the slit hole earlier than the first portion.

20. The battery module manufacturing method according to claim 18, wherein the length of the second portion in a direction in which the electrode tab protrudes is shorter than the length of the first portion in a direction in which the electrode tab protrudes.
